(19) United States
(12) Patent Application Publication
(10) Pub. No.: US 2023/0358937 A1
(43) Pub. Date: Nov. 9, 2023

(54) LAMINATED GLAZING WITH REDUCED OUTSIDE LIGHT REFLECTION AND HEAD-UP DISPLAY WITH IMPROVED VISIBILITY

(71) Applicant: SAINT-GOBAIN GLASS FRANCE, COURBEVOIE (FR)

(72) Inventor: Antoine DIGUET, PARIS (FR)

(21) Appl. No.: 18/041,949

(22) PCT Filed: Sep. 8, 2021
(86) PCT No.: PCT/FR2021/051538

§ 371 Date: Feb. 16, 2023

(30) Foreign Application Priority Data
Sep. 14, 2020 (FR) FR2009270

(51) Int. Cl. B32B 17/10; G02B 27/01; G02B 5/30

(52) U.S. Cl. CPC G02B 5/3066; B32B 17/10036; B32B 17/1022; B32B 17/10385; B32B 17/10633; B32B 17/1066; B32B 17/10761; G02B 27/0101; B32B 2307/102; B32B 2307/412; B32B 2307/42; B32B 2307/7376; B32B 2605/006; G02B 2027/0118

(57) ABSTRACT

A laminated glazing with light transmission LT in the visible spectrum of at least 70%, includes two clear glass sheets bonded to one another by an adhesive interlayer, wherein one of the two faces of the glass sheets on the inside of the laminated structure is coated with a stack of thin layers adapted to reflect at least 17% of p-polarized light projected under an incident angle of 65°, and wherein the adhesive interlayer is tinted so as to absorb 5 to 25% of visible light.

The invention relates to a windscreen with a head-up display (HUD). The main problem to be solved for the optical quality of a windscreen with HUD function is the double image reflected on the inside of the glazing, viewed by the driver.

One technology for solving this problem consists of using a projector emitting p-polarized light. When such light is projected with a specific angle of incidence referred to as Brewster’s angle on the internal face of the windscreen (i.e., the free face oriented towards the passenger compartment of the vehicle), the reflection on each of the two air/glass interfaces of the laminated glazing, i.e., the interface of the lamination with the outside atmosphere, referred to as face 1, and the interface of the lamination with the inside volume of the vehicle (passenger compartment), referred to as face 4 in the case of a lamination with two glass sheets, is removed. The use of a thin-film metal coating on face 2 or 3 of the laminated glazing, i.e., the inside face of the laminated structure of the outer or inner glass sheet, makes it possible to reflect part of the p-polarized light towards the eyes of the driver, forming a single image, and no longer a duplicated image. This technique is disclosed in application WO 2016058474. The reflectivity of the p-polarized light is comprised between 5 and 10%, which is certainly low for good visibility of the HUD image. One of the advantages of this HUD technology is that the driver wearing p-polarizing spectacles benefits from considerably increased contrast between the HUD image and the outside environment.

The invention is part of the Applicant’s internal knowledge of the possibility to design stacks of thin layers able to reflect up to more than 20% of a p-polarized light, instead of 5 to 10% as previously described. It has however been noted that such stacks with high reflectivity of p-polarized light, on the inside of the lamination in assembled position, have high reflection of non-polarized light LR from the outside of the laminated glazing, of approximately 20%.

This high light reflection LR is not desirable. Indeed, it unaesthetically increases the contrast with the other neighboring glazings (motor vehicle side windows) and with the bodywork. By way of comparison, the current light reflection LR of laminated glazings with clear glass sheets not provided with a thin layer is 12%. Furthermore, the visibility of the driver through the windscreen, from the outside of the vehicle, is reduced, which may cease to be acceptable in regulatory terms, in the future.

The invention has the aim of maintaining excellent visibility by the driver of a HUD image, i.e., a high inside reflection for the p-polarized light, while reducing the outside light reflection. This objective has been achieved by the invention which, as a result, has as its object a laminated glazing with light transmission LT in the visible spectrum of at least 70%, consisting of two clear glass sheets bonded to one another by an adhesive interlayer, characterized in that one of the two faces of the glass sheets on the inside of the laminated structure is coated with a stack of thin layers able to reflect at least 17% of p-polarized light projected under an incident angle of 65°, and in that the adhesive interlayer is tinted so as to absorb 5 to 25% of visible light.

Light transmission LT in the visible spectrum of at least 70% is a general regulatory safety requirement. This requirement can also be expressed by the fact that the sum of the outside light reflection in the visible spectrum, the visible light absorption of the tinted adhesive interlayer and the visible light absorption of the reflective stack of layers is at most equal to 30%. When, according to the invention, a tinted adhesive interlayer absorbing 15% of visible light, and a single-silver reflective stack of layers (with a single layer of silver) absorbing 5% of visible light are for example used, the outside light reflection in the visible spectrum is thus reduced to a maximum value of 10%; actually, the outside LR value can exceed 10% without departing from the scope of the invention, and is furthermore at least 5%. Aesthetic harmony with neighboring glazings and the surface of the motor vehicle bodywork, is guaranteed.

Furthermore, the outstanding visibility of the HUD image is also guaranteed by virtue of the high reflectivity of p-polarized light of the reflective stack of thin layers. The incident angle of the p-polarized light on the internal face of the windscreen is currently 65°, close enough to the Brewster’s angle for an air/glass interface (57.2°, soda-lime glass) in order to render the reflection of p-polarized light at these two interfaces negligible, and so that the p-polarized light is mainly reflected by the reflective stack of layers. In the sense of the invention, the fact that the stack of layers is able to reflect at least 17% of p-polarized light is understood to mean that it does so as long as it is placed between the projector emitting the p-polarized light and the tinted adhesive interlayer.

The clear glass consists of mineral glass, such as float, soda-lime, aluminosilicate, or borosilicate. At least one of the two glass sheets can be hardened, semi-tempered or chemically strengthened particularly in the case of thin glass (indicative thickness 0.7 mm). The term “clear glass” is intended to refer to glass which has zero absorption of visible light. The laminated glazing, the two glass sheets, are very generally curved. Examples of an adhesive interlayer are polyvinyl butyral (PVB), thermoplastic polyurethane (TPU), or an ethylene vinyl acetate copolymer (EVA).

It is known to tint an adhesive interlayer by introducing organic dyes or mineral pigments into the polymer material, or after extrusion (dipping, spraying, etc.). It is also known to tint by one of these methods to a perfectly controlled degree of absorption of visible light.

It is particularly advantageous to use two clear glass sheets of the same composition, which simplifies the bending process.

The optical parameters used relative to the invention, such as light transmission LT in the visible spectrum, outside light reflection LR, inside reflection for the p-polarized light, haze, refer to visible light with wavelengths comprised between 380 and 780 nm, and to standard NF EN-410 applied to an automotive windscreen. The values belong to the visible spectrum. The illuminant A, and the measurement angles of 0° for the light transmission, 0 and 60° for the outside light reflection, and 65° for the inside reflection for p-polarized light are used.

The haze of the laminated glazing of the invention should be maintained at a low value customary in the application as a windscreen, for example, of at most 2, preferably 1%.

The mechanical properties of the laminated glazing of the invention are similar to those of standard laminated glazings, they can be controlled in the same manner to ensure the good mechanical strength of the windscreen and avoid having to modify the laminating process.

Preferably, the stack is able to reflect at least 19% of p-polarized light.

Preferably, the stack is silver-based, and comprises, in a particularly preferred way, a single layer of silver. In this case, according to a first variant, the layer of silver is inserted between two alternations of layers with high and low refractive index, and according to a second variant, the stack contains mainly, in addition to the layer of silver, layers with high refractive index, such as SiZrN. “High and low refractive index” is understood herein to mean “relatively high and relatively low refractive index”, a ZnOₓ layer having for example a relatively low refractive index (with respect to that of other layers) of 1.9.

Preferably, the thickness of each of the two glass sheets is comprised between 0.5 and 2.5 mm.

Preferably, the tinted adhesive interlayer consists of polyvinyl butyral (PVB) and has a thickness comprised between 0.38 and 1.52 mm.

Preferably, the adhesive interlayer comprises an upper strip tinted to a greater degree, so as to absorb 40 to 100% of visible light. This overtinted upper strip has a parasol function.

In a certain embodiment, the dyes of the tinted adhesive interlayer can absorb visible light only while remaining grey, the stack of layers such as silver reflecting the near-infrared to the outside of the glazing. In another embodiment, the dyes of the tinted adhesive interlayer absorb visible and near-infrared light, for example by the fact that the adhesive interlayer contains nanoparticles of cesium-doped tungsten oxide WOₓ:Cs so as to absorb the light with wavelengths comprised between 750 and 1200 nm. In both cases, near-infrared transmission is reduced, offering thermal comfort.

Preferably, the adhesive interlayer has a composition or a structure that grants it an acoustic damping property, particularly a three-layer structure.

Preferably, the free face of the glass sheet coated with a reflective stack of thin layers comprises an anti-reflective coating, which can consist of a material with low refractive index, such as a SiOₓ coating obtainable by a sol-gel process, or a thin stack of layers made of materials with low and high alternating refractive indices, which can be obtained by a magnetron process (vacuum cathode sputtering — reduced pressure — assisted by magnetic field), for example. This technical measure makes it possible to do away with the minimal fraction of light that may still be reflected on the internal face (in contact with the passenger compartment of the motor vehicle or the like) of the laminated glazing. Such a residual reflection is likely to originate from a considerable deviation of the angle of incidence of the p-polarized light with respect to the Brewster’s angle, or from the use of a projector emitting a significant fraction of non p-polarized light.

Preferably, two opposing edges of the surface of the reflective stack of thin layers are connected to electrodes connected to an electric power supply, so as to make the stack heatable, particularly to provide a defogging, defrosting function.

The invention also has as its object a system comprising a laminated glazing and a projector of p-polarized light, wherein the laminated glazing has a light transmission LT in the visible spectrum of at least 70%, consists of two clear glass sheets bonded to one another by an adhesive interlayer, the p-polarized light is projected onto the laminated glazing according to an incident angle that does not vary from the Brewster’s angle of the air/clear glass interface by more than 15°, characterized in that the face on the inside of the laminated structure of the glass sheet closest to the projector is coated with a stack of thin layers able to reflect at least 17% of p-polarized light projected under an incident angle of 65°, and in that the adhesive interlayer is tinted so as to absorb 5 to 25% of visible light.

The invention also relates to the application of a laminated glazing as described previously as a windscreen with a head-up display HUD, wherein the glass sheet coated with a reflective stack of thin layers is oriented towards the side of the passenger compartment of the vehicle, and a projector emits p-polarized light onto the free surface of the laminated glazing on the side of the passenger compartment of the vehicle according to an incident angle that does not vary from the Brewster’s angle by more than 15°.

The invention will be better understood in light of the following example.

### EXAMPLE

Five compositions of laminated glazings according to the invention are disclosed in the table hereunder.

TABLE 1

| | | | | | |
|---|---|---|---|---|---|
| material | 1 | 2 | 3 | 4 | 5 |
| Soda-lime glass | 2.1 mm | 2.1 mm | 2.1 mm | 2.1 mm | 2.1 mm |
| PVB | 0.76 mm | 0.76 mm | 0.76 mm | 0.76 mm | 0.76 mm |
| SiN | 70 nm | 70 nm | 60 nm | 60 nm | 60 nm |
| SiZrN | | | | 10 nm | 10 nm |
| ZnO | | | 10 nm | 10 nm | 10 nm |
| NiCr | 0.3 nm | 0.3 nm | 0.3 nm | 0.3 nm | 0.3 nm |
| Ag | 11 nm | 12 nm | 12 nm | 11 nm | 13 nm |
| ZnO | | | 10 nm | 10 nm | 10 nm |
| SiZrN | | | | 10 nm | 10 nm |
| SiN | 30 nm | 35 nm | 25 nm | 20 nm | 20 nm |
| Soda-lime glass | 2.1 mm | 2.1 mm | 2.1 mm | 2.1 mm | 2.1 mm |

The PVB is tinted so as to absorb 15% of visible light.

1. A laminated glazing with light transmission LT in the visible spectrum of at least 70%, consisting of two clear glass sheets bonded to one another by an adhesive interlayer to form a laminated structure, wherein one of the-two faces of the two clear glass sheets on an inside of the laminated structure is coated with a stack of thin layers adapted to reflect at least 17% of p-polarized light projected under an incident angle of 65°, and wherein the adhesive interlayer is tinted so as to absorb 5 to 25% of visible light.

2. The laminated glazing according to claim 1, wherein the stack of thin layers is adapted to reflect at least 19% of p-polarized light.

3. The laminated glazing according to claim 1, wherein the stack of thin layers includes silver.

4. The laminated glazing according to claim 1, wherein the stack of thin layers comprises a single layer of silver.

5. The laminated glazing according to claim 4, wherein the layer of silver is inserted between alternations of layers with high and low refractive index.

6. The laminated glazing according to claim 4, wherein the stack of thin layers mainly contains, in addition to the layer of silver, layers with high refractive index.

7. The laminated glazing according to claim 1, wherein a thickness of each of the two glass sheets is comprised between 0.5 and 2.5 mm.

8. The laminated glazing according to claim 1, wherein the tinted adhesive interlayer consists of polyvinyl butyral (PVB) and has a thickness comprised between 0.38 and 1.52 mm.

9. The laminated glazing according to claim 1, wherein the adhesive interlayer comprises an upper strip tinted to a greater degree, so as to absorb 40 to 100% of visible light.

10. The laminated glazing according to claim 1, wherein dyes of the tinted adhesive interlayer absorb visible and near-infrared light.

11. The laminated glazing according to claim 10, wherein the adhesive interlayer contains nanoparticles of cesium-doped tungsten oxide WOₓ:Cs so as to absorb light with wavelengths comprised between 750 and 1200 nm.

12. The laminated glazing according to claim 1, wherein the adhesive interlayer has a composition or a structure that grants it an acoustic damping property.

13. The laminated glazing according to claim 1, wherein a free face of the glass sheet coated with the stack of thin layers comprises an anti-reflective coating.

14. The laminated glazing according to claim 1, wherein two opposing edges of a surface of the stack of thin layers are connected to electrodes connected to an electric power supply, so as to make the stack of thin layers heatable.

15. A system comprising a laminated glazing and a projector of p-polarized light, wherein the laminated glazing has a light transmission LT in the visible spectrum of at least 70%, consists of two clear glass sheets bonded to one another by an adhesive interlayer to form a laminated structure, the p-polarized light is projected onto the laminated glazing according to an incident angle that does not vary from the Brewster’s angle of the air/clear glass interface by more than 15°, wherein a face on an inside of the laminated structure of one of the two clear glass sheets closest to the projector is coated with a stack of thin layers adapted to reflect at least 17% of p-polarized light projected under an incident angle of 65°, and wherein the adhesive interlayer is tinted so as to absorb 5 to 25% of visible light.

16. A method comprising providing a laminated glazing according to claim 1 as a windscreen with a head-up display HUD of a vehicle, wherein the clear glass sheet of the two clear glass sheets that is coated with a reflective stack of thin layers is oriented towards the a side of the a passenger compartment of the vehicle, and a projector emits p-polarized light onto the a free surface of the laminated glazing on the side of the passenger compartment of the vehicle according to an incident angle that does not vary from the Brewster’s angle by more than 15°.

17. The laminated glazing according to claim 12, wherein the structure is a three-layer structure.
